(19) United States
(12) Patent Application Publication
(10) Pub. No.: US 2025/0316839 A1
(43) Pub. Date: Oct. 9, 2025

(54) High Density Polyethylene Micropowders, Processes for Making Same, and Uses Thereof

(71) Applicant: Celanese International Corporation, Irving, TX (US)

(72) Inventors: Victoria Black, Cincinnati, OH (US); Argiri Tsami-Schulte; Layane Deghedi, Illkirch-Graffenstaden (FR); Rainer Walkenhorst, Melle (DE); Richard Moore, Florence, KY (US); Christian Ohm, Sulzbach (DE); Cheng Wan, Shanghai (CN)

(21) Appl. No.: 19/172,767

(22) Filed: Apr. 8, 2025

Related U.S. Application Data
(60) Provisional application No. 63/660,623, filed on Jun. 17, 2024.
(60) Provisional application No. 63/726,771, filed on Dec. 2, 2024.

(30) Foreign Application Priority Data
Apr. 9, 2024 (WO) PCT/CN2024/086693

(51) Int. Cl. H01M 50/417; C08F 110/02

(52) U.S. Cl. CPC H01M 50/417; C08F 110/02; C08F 2810/20

(57) ABSTRACT

A polymer micropowder is disclosed made from a high density polyethylene polymer. In one aspect, the polymer micropowder is produced through a grinding process. The high density polyethylene particles, for instance, can initially have a multilobal shape that includes nodes that are broken off during the grinding process to produce the micropowder. The resulting polymer micropowder has a very low bulk density.

### RELATED APPLICATIONS

The present application is based upon and claims priority to International Patent Application No. PCT/CN2024/086693, having a filing date of Apr. 9, 2024, and U.S. Provisional Patent Application Ser. No. 63/660,623, having a filing date of Jun. 17, 2024, both of which are incorporated herein by reference in their entirety.

### BACKGROUND

Polyethylene polymers have numerous and diverse uses in applications. For example, high density polyethylene polymers, including high molecular weight and ultrahigh molecular weight polyethylene polymers, are valuable engineering plastics with a unique combination of abrasion resistance, surface lubricity, chemical resistance, and impact strength.

High density polyethylene polymers are commercially available in different grades that vary by molecular weight and/or particle size. In the past, particle sizes have typically ranged from about 20 microns to about 500 microns or larger.

Recently, those skilled in the art have attempted to produce high molecular weight polyethylene particles having particle sizes of smaller than about 25 microns. For instance, Mitsui Chemicals recently began marketing an ultrahigh molecular weight polyethylene powder having a particle size of from 10 microns to about 65 microns under the name MIPELON polymer additive. In addition, JP 2011-80013, which is incorporated herein by reference, discloses a process for producing ultrahigh molecular weight polyethylene particles having a fine particle size. As disclosed in the JP '013 application, the polyethylene particles are produced using a complex polymer catalyst that produces particles having a smooth spherical shape. The particles, however, have a relatively high bulk density in addition to displaying a high Shore D hardness and a relatively high melting point. These characteristics and properties can create problems in incorporating the particles into various different applications, such as when using the particles in gel extrusion processes. In addition, the particles can be relatively expensive to produce.

In view of the above, a need exists for very fine high density polyethylene particles that have improved characteristics and properties that make them well suited for use in various polymer processes.

### SUMMARY

In general, the present disclosure is directed to a polymer micropowder made from high density polyethylene particles. The micropowder can be formed by grinding high density polyethylene particles. In one aspect, the high density polyethylene particles that are ground have a unique morphology. For instance, the high density polyethylene polymer particles can have a multilobal shape comprised of a network of nodes. During grinding, it is believed that the nodes break off producing a particle size distribution in which the median particle size is very small. The resulting micropowder can possess properties and characteristics that make the micropowder well suited for use in many polymer applications. For instance, the micropowders of the present disclosure are particularly well suited for producing gel extruded articles, such as porous membranes for use in ion batteries. The micropowder is also well suited for use as a binder in producing electrodes in energy storage devices. In addition, the micropowder is also well suited for producing porous sintered structures or articles. The sintered structures can have a small pore size.

In one embodiment, for instance, the present disclosure is directed to a polymer micropowder comprising polymer particles having a median particle size (D50) of less than about 15 microns, such as less than about 14 microns, such as less than about 12 microns, such as less than about 10 microns, such as even less than about 9 microns. The median particle size (D50) is generally greater than about 2 microns, such as greater than about 4 microns, such as greater than about 6 microns, such as greater than about 7 microns. The polymer particles comprise a high density polyethylene polymer. The high density polyethylene polymer can have an average molecular weight of greater than about 300,000 g/mol, such as greater than about 400,000 g/mol, such as greater than about 500,000 g/mol, such as greater than about 650,000 g/mol, such as greater than about 800,000 g/mol, such as greater than about 1,000,000 g/mol, such as greater than about 1,200,000 g/mol, such as greater than about 1,500,000 g/mol, such as greater than about 1,700,000 g/mol, such as greater than about 1,900,000 g/mol, and less than about 13,000,000 g/mol.

The polymer micropowder of the present disclosure not only has a relatively small particle size but can also be formed with a relatively low bulk density. For instance, the polymer particles can display a bulk density of less than about 0.39 g/cm³ when tested according to ISO Test 60. For instance, the bulk density of the polymer particles can be less than about 0.38 g/cm³, such as less than about 0.36 g/cm³, such as less than about 0.34 g/cm³, such as less than about 0.32 g/cm^{3,} such as less than about 0.3 g/cm³, such as less than about 0.28 g/cm³.

In one aspect, the polymer particles can comprise ground particles. For instance, in one embodiment, high density polyethylene particles having a multilobal shape comprising a network of nodes can be ground. The resulting polymer particles can comprise remnants of the nodes that have been separated from the multilobal-shaped polymer particles. In one aspect, at least a portion of the high density polyethylene polymer contained in the particles can be crosslinked.

The high density polyethylene polymer contained within the polymer particles can display a relatively high melting temperature or a low melting temperature. In one aspect, the high density polyethylene polymer can have a melting temperature of greater than about 135.5° C., such as greater than about 137° C. Alternatively, the high density polyethylene polymer can a melting temperature of less than about 135.5° C., such as less than about 135.1° C. The high density polyethylene polymer can also display a relatively low Shore D hardness. For instance, the Shore D hardness can be less than about 63, such as less than about 61. Alternatively, the Shore D hardness can be greater than about 64, such as greater than about 68.

The present disclosure is also directed to molded articles made from the polymer micropowder as described above. In one aspect, the molded article can be made through a gel extrusion process. The molded article, for instance, can comprise a porous membrane well suited for use as a separator between an anode and a cathode in an ion battery, such as a lithium ion battery or a sodium ion battery. The porous membrane can be formed to have a porosity of from about 25% to about 60% and a Gurley permeability of from about 50 sec/100 mL to about 500 sec/100 mL. The porous membrane can have a thickness of from about 3 microns to about 25 microns, such as from about 4 microns to about 12 microns.

The polymer micropowder of the present disclosure can also be used as a binder to produce electrodes for energy storage devices. In one aspect, for instance, the electrode can be a film comprising a network of an active material held together by the binder. The film can be formed through heat and pressure. The active material can comprise a material capable of producing metal ions or can comprise a material containing carbon, such as graphite. The electrode, for instance, can serve as a cathode or an anode.

The present disclosure is also directed to a process for producing a polymer micropowder. The process can include grinding high density polyethylene particles to form the polymer micropowder. The high density polyethylene particles can have a multilobal shape comprising a network of nodes attached together. During grinding, the nodes can be separated from the multilobal-shaped particles for forming the micropowder. The resulting micropowder can have a median particle size (D50) of less than about 15 microns, such as less than about 14 microns, such as less than about 12 microns, such as less than about 10 microns, such as less than about 9 microns.

In one embodiment, the high density polyethylene polymer can be at least partially crosslinked prior to grinding. The high density polyethylene polymer can be crosslinked by exposing the multilobal-shaped particles to irradiation, such as x-rays or gamma rays.

In one aspect, the high density polyethylene particles can be ground in the presence of a grinding aid. The grinding aid can be water soluble. For instance, the grinding aid can comprise sodium chloride particles. In another embodiment, the grinding aid can comprise particles made of zircon, zirconium, quartz, or mixtures thereof.

Other features and aspects of the present disclosure are discussed in greater detail below.

### BRIEF DESCRIPTION OF THE DRAWINGS

A full and enabling disclosure of the present disclosure is set forth more particularly in the remainder of the specification, including reference to the accompanying figures, in which:

FIG. 1 is a perspective view of high density polyethylene particles having a multilobal shape prior to grinding in accordance with the present disclosure;

FIG. 2 is a perspective view of a polymer micropowder made in accordance with the present disclosure comprised of remnants of nodes separated from the multilobal-shaped polymer particles illustrated in FIG. 1;

FIG. 3 is a cross-sectional view of an energy storage device illustrating a first electrode or cathode spaced from a second electrode or anode and separated by a porous membrane or separator; and

FIG. 4 is a side view of one embodiment of a process for forming an electrode film in accordance with the present disclosure.

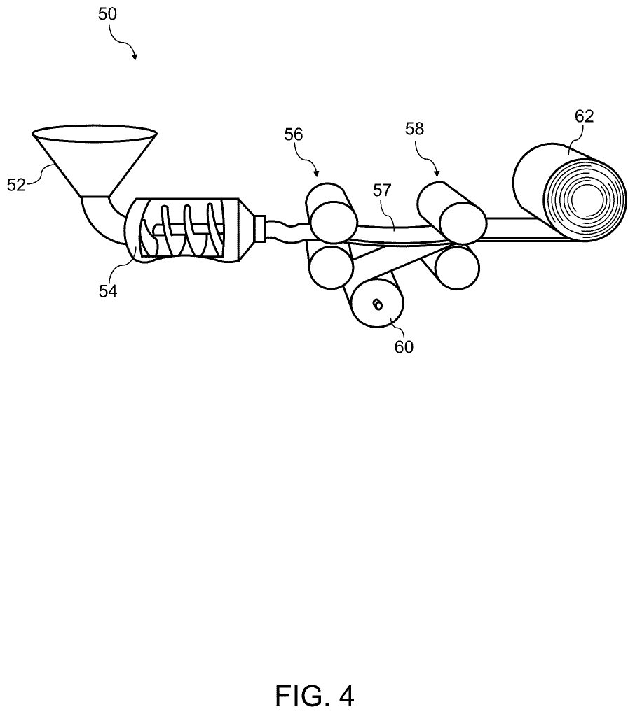

Repeat use of reference characters in the present specification and drawings is intended to represent the same or analogous features or elements of the present invention.

### DEFINITIONS

The melt flow rate of a polymer or polymer composition is measured according to ISO Test 1133 at 190° C. and at a load of 21.6 kg.

The density of a polymer is measured according to ISO Test 1183 in units of g/cm³.

Average particle size (d50) is measured using laser diffraction/light scattering, such as a suitable Horiba light scattering device.

The average molecular weight of a polymer is determined using the Margolies' equation. Molecular weight can be determined by first measuring the viscosity number according to DIN EN ISO Test 1628. Dry powder flow is measured using a 25 mm nozzle.

Tensile modulus, tensile stress at yield, tensile strain at yield, tensile stress at 50% break, tensile stress at break, and tensile nominal strain at break are all measured according to ISO Test 527-2/1B.

The full width at half maximum of a melting endothermic peak of a sample is measured with a differential scanning calorimeter (DSC). An electronic balance is used to measure 8.4 g of a sample. The sample is placed in an aluminum sample pan. An aluminum cover is attached to the pan, which is set in the differential scanning calorimeter. The sample and a reference sample are retained at 40° C. for one minute while nitrogen purge is performed at a flow rate of 20 mL/min then heated from 40°° C. to 180° C. at a heating rate of 10° C./min, retained at 180° C. for 5 minutes, and then cooled to 40°° C. at a cooling rate of 10° C./min. A baseline is drawn from 60°° C. to 150° C. in the melting curve acquired during the process and the full width at half maximum of a melting endothermic peak is derived using analysis software, such as “Pyris Software (Version 7).” The test can be conducted using a DSC Q2000 calorimeter available from TA Instruments.

The half-crystallization period of time during an isothermal crystallization at 123° C. can be determined from the time that requires a quantity of heat measured during an isothermal crystallization measurement at 123° C. to correspond to the half of the peak area in differential scanning calorimetry (DSC) measurement. The test can be conducted using a DSC Q2000 calorimeter available from TA Instruments.

Contact angle measurements are performed on a Kruss DSA 100 instrument. A membrane sample (10×40 mm) is attached to a microscope slide using double sided adhesive tape. Static charging is dissipated by moving the prepared sample several times through a U-electrode static discharger. The sample is mounted in a measurement device and a 3.5 μl droplet of testing fluid (water or ethyleneglycol) is placed on the membrane. The contact angle is determined through the software for 7 seconds (one measurement per second) after placement of the droplet. These 7 data points are averaged to yield the contact angle at the point of measurement. Every sample is measured at 6different spots or locations on each side and all results are averaged to the reported value.

A soaking test may be used to determine the wicking characteristics of membranes made in accordance with the present disclosure according to the following procedure.

For the soaking test a glass vessel is used with following dimensions: 20×10 cm upper area (covered with a metal plate)/19×8 cm lower area (base)/height: 10 cm). Two filter papers are sticked at the inside of the glass vessel with a tape. 300 ml propylene carbonate is filled into the vessel afterwards (fluid level: 2cm). The vessel is covered with a metal plate and propylene carbonate is allowed to fill the gas space for 20 minutes.

Membranes are cut with scissors into pieces (length: 70 mm, width: 7 mm). This is done with nitrile gloves to prevent touching the membranes with the bare hand. The pieces are mounted on an anodized metal plate (140 mm×70 mm, frame width: 10 mm, slope: 80°) with the help of magnets. The MD direction of membranes shows upwards (=soaking direction).

The metal frame with the fixed membranes are then moved 40 times through a deionizer to remove electrostatic charges. After that the frame is placed into the vessel filled with propylene carbonate at room temperature and soaking of the membranes with propylene carbonates takes place for a desired time. During soaking takes place the vessel is closed with a metal plate. The different soaking distances of the membranes are measured every 30 minutes by taking a photo and measuring the distance with a suitable computer program.

Soaking distances of tested membranes is compared to draw conclusion on their battery electrolyte affinity.

Gurley permeability can be measured according to the Gurley Test, using a Gurley permeability tester, such as Gurley Densometer, Model KRK 2060c commercially available from Kumagai Riki Kogyo Co., LTD. The test is conducted according to ISO Test 5636. The Gurley Test measures air permeability as a function of the time required for a specified amount of air to pass through a specified area under a specified pressure. The units are reported in sec/100 ml.

Porosity (%) is measured according to the following procedure. During the procedure, the following ASTM Standards are used as a reference: D622 Standard Test Method for Apparent Density of Rigid Cellular Plastics1; and D729 Standard Test Methods for Density and Specific Gravity (Relative Density) of Plastics by Displacement1. The following instruments are used: Calibrated Analytical Balance (0.0001 grams); Lorentzen & Wettre Micrometer,code 251 (0.1um); and Deli 2056 art knife.

### Procedure:

### 1.1. Samples and Sample Preparation

Using the specimen art knife, cut each sample material into a minimum of three 60 mm±0.5 by 60 mm±0.5 specimens

### 1.2. Instrument and Measurement

3.2.1 Using the L&W micrometer, take five readings of the thickness at each 60 mm by 60 mm specimen (average of 5 readings). Record this value as the thickness of this specimen.
3.2.2 Weigh the specimen directly on the balance. Record this value as the weight of this specimen.
3.2.3 The three specimens of the same sample are placed together and steps 3.2.1 and 3.2.2 are repeated to obtain the [bulk] thickness and the [bulk] weight.

### Calculate the Density to Three Significant Figures as Follows

$$a . Dfilm = Density ( film ) = Wt . of Specimen$$

$$THK * Square$$

$$Dfilm = density of specimen , ( mg / mm 3 )$$

$$Wt = weight of specimen , ( mg )$$

$$THK = thickness of specimen , ( mm )$$

$$Square = area of specimen , ( mm 2 )$$

$$b . Dpolymer = Density ( polymer ) 0.95 ( g / cm 3 )$$

$$Dpolymer : Density of raw materials , without the pores .$$

$$c . Porosity = ( 1 - Dfilm / Dpolymer ) * 100 \%$$

As used herein, puncture strength is measured according to ASTM Test D3763 and measures the ability of a membrane to withstand a foreign particle from causing a hole or defect. The test is conducted on a testing device, such as an Instron CEAST 9340 device. The drop height is 0.03 to 1.10 m. The impact velocity is 0.77 to 4.65 m/s. The maximum dropping mass is 37.5 kg and the maximum potential energy is 405 J. Puncture strength is measured in slow speed puncture mode at 1.67 mm/s. Puncture strength can be normalized by dividing by the thickness of the membrane resulting in units of mN/micron.

Heat shrinkage of a membrane is determined by putting a piece of membrane (3 in×3 in) in an oven at 105° C. for 1 h. Shrinkage is calculated by measuring the size in MD and TD direction before and after heat treatment.

As used herein, bulk density is measured according to DIN 53466.

As used herein, particle size is measured utilizing a laser defraction method according to ISO Test 13320.

### DETAILED DESCRIPTION

It is to be understood by one of ordinary skill in the art that the present discussion is a description of exemplary embodiments only and is not intended as limiting the broader aspects of the present disclosure.

In general, the present disclosure is directed to a polymer micropowder comprised of high density polyethylene polymer particles. The polyethylene polymer particles can be made from a high molecular weight polyethylene polymer or an ultrahigh molecular weight polyethylene polymer. In one aspect, the polymer micropowder is formed through grinding larger high density polyethylene particles. In one aspect, the particles being ground can have a multilobal shape and can comprise a network of nodes attached together. During grinding, the nodes become separated from the particle forming the micropowder. The resulting micropowder, for instance, can have a median particle size (D50) of less than about 15 microns.

The polymer micropowder of the present disclosure can offer numerous advantages and benefits. For instance, the polymer micropowder can have a relatively low bulk density which can lead to enhanced processability and improved dispersion. For instance, the smaller particles can exhibit better flow properties that can be more easily processed using techniques, such as extrusion or injection molding. This can result in improved manufacturability and lower production costs. In addition, the finer particles of the present disclosure have a particle morphology that causes the particles to disperse more evenly, uniformly, and faster in matrices such as other polymers, plasticizers, or solvents. This can result in more uniform properties throughout the resulting article and better performance especially in applications where the polymers are used to produce components in an energy storage device, such as a battery.

The extremely fine particles of the present disclosure can also lead to enhanced mechanical properties, such as tensile strength, impact resistance, and stiffness. This is particularly useful in applications where strength and durability are important, such as when producing porous membranes or separators for energy storage devices.

The polymer micropowder of the present disclosure also contains very fine particles that have a higher surface area-to-volume ratio, which can be advantageous in many applications. The increased surface area can improve adhesion, bonding, and interaction with other materials.

In addition, by reducing and controlling the particle size distribution of the particles contained in the polymer micropowder, it is possible to tailor the properties of the high density particles to specific applications. In this manner, improvements can be achieved in producing desired rheological behavior, surface roughness, and/or barrier properties. Overall, the high density polymer micropowder of the present disclosure containing particles having a median particle size of less than about 15 microns offers a range of benefits that can lead to improved performance and versatility in many different applications.

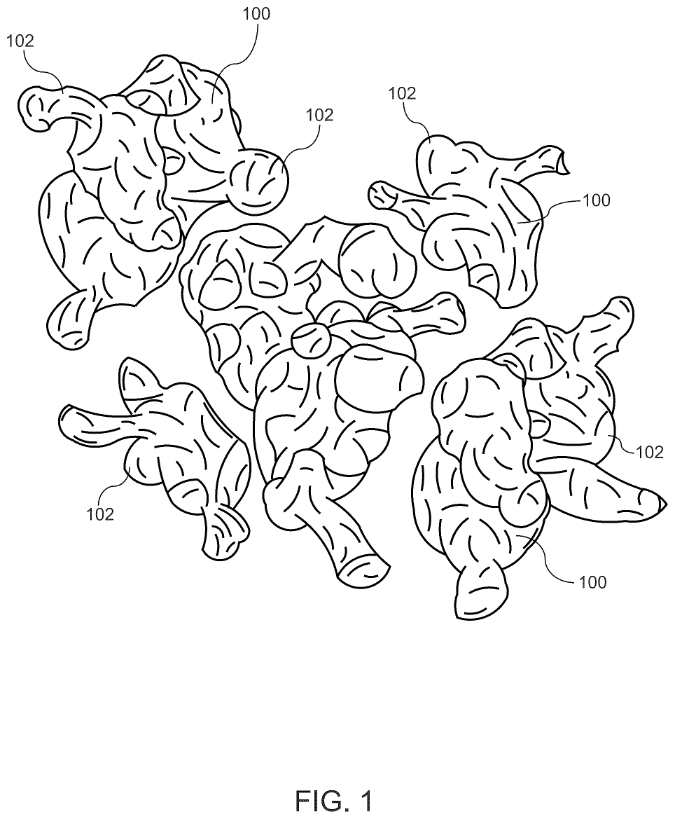

As described above, in one aspect, the polymer micropowder of the present disclosure can be formed by grinding larger high density polyethylene polymer particles. For instance, referring to FIG. 1, a plurality of high density polyethylene particles 100 are shown. In one embodiment, the starting particles have an irregular shape as illustrated in FIG. 1. More particularly, the particles 100 can have a multilobal shape that comprise a network of nodes 102 that can project from the surface of the particles 100. As shown, for instance, the particles 100 display a globular or bulbous surface. The high density polyethylene particles 100 are non-fibrous and have a relatively high surface area due to the presence of the plurality of nodes 102.

The initial size of the high density polyethylene particles 100 can vary depending upon the particular application. For instance, the particles 100 can have a median particle size (D50) of less than about 500 microns, such as less than about 400 microns, such as less than about 300 microns, such as less than about 200 microns, such as less than about 150 microns, such as less than about 120 microns, such as less than about 100 microns, such as less than about 70 microns. The median particle size of the high density polyethylene polymer particles 100 is generally greater than 25 microns, such as greater than about 30 microns, such as greater than about 40 microns, such as greater than about 50 microns, such as greater than about 60 microns, such as greater than about 70 microns.

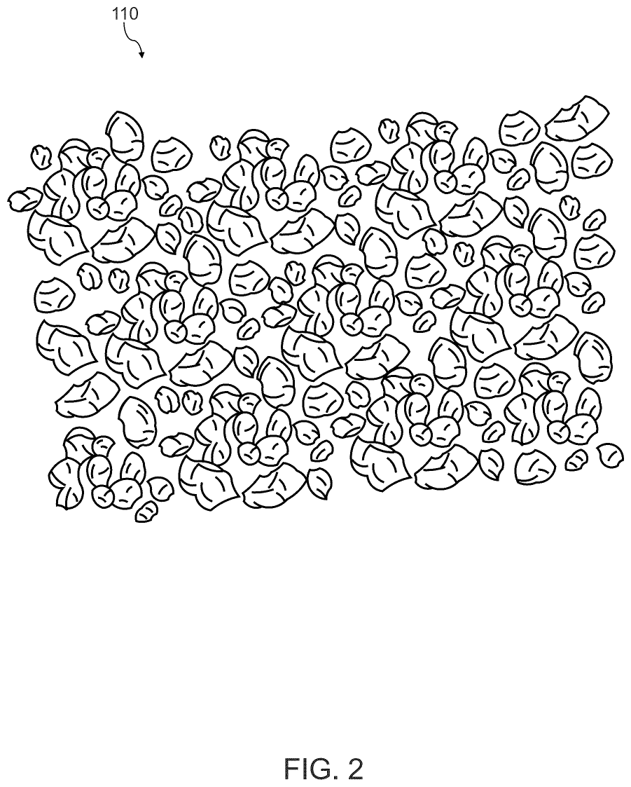

In accordance with the present disclosure, the particles 100 as shown in FIG. 1 can be fed through a grinding process which, as used herein, also includes milling processes. During the grinding process, the high density polyethylene polymer particles 100 are ground down to a desired particle size. For instance, referring to FIG. 2, the resulting high density polyethylene polymer ground particles 110 are shown. During grinding, the particles are broken down into very fine particles. During the process, at least certain of the nodes 102 are broken off from the rest of the particle for forming very small particles having the desired characteristics of the present disclosure.

In general, any suitable grinding process can be used that is capable of breaking down the high density polyethylene polymer particles 100 as shown in FIG. 1. In one aspect, for instance, jet milling may be used to reduce the particle size. During jet milling, the high density polyethylene polymer particles 100 as shown in FIG. 1 can optionally be dried and/or sieved to ensure uniformity in size and moisture content. In one aspect, the large high density polyethylene particles 100 are fed into a milling chamber. The milling chamber can be a cylindrical chamber with nozzles or jets positioned on the periphery of the chamber. During grinding, high pressure gas or air is used to create high speed fluid jets within the milling chamber. These jets are directed towards the particles. As the high-speed fluid jets collide with the high density polyethylene particles, they impact kinetic energy to the particles. This energy causes the particles to collide with each other and with the walls of the milling chamber. These collisions lead to fracturing of the particles into much smaller sizes.

Optionally, after milling, the resulting ground particles can be classified based on their size using an air classifier. For instance, if necessary or desired, the smaller particles can be separated from the coarser particles. The finer particles can be collected, while the coarser particles may undergo further milling steps. The fine high density polyethylene particles can be collected using any suitable process or technique. For instance, a cyclone separator or a bag filter may be used to collect the resulting particles.

Jet milling may offer some advantages over other grinding processes. For instance, jet milling allows for precise control over the particle size distribution. Jet milling can also be efficient in reducing particle size in which very fine particle sizes can be obtained in a relatively short amount of time. Jet milling can also be scaled up to accommodate large production volumes.

High density polyethylene particles 100 as shown in FIG. 1, however, can be difficult to grind due to the properties of the polymer, including high impact strength. Using particles having a multilobal shape, however, can facilitate the grinding process for producing the smaller particles.

In addition to using multilobal-shaped particles (or in lieu of using such particles), various other techniques and methods can be used in order to facilitate desizing or particle size reduction. For instance, in one embodiment, prior to grinding the high density polyethylene particles, the polyethylene polymer contained in the particles can be crosslinked or at least partially crosslinked. The high density polyethylene polymer can be crosslinked using any suitable method. For instance, a chemical crosslinking agent can be incorporated into the polymer or the polymer particles can be exposed to irradiation. For example, the high density polyethylene particles can be crosslinked using either x-rays or gamma rays through a process called radiation crosslinking. This process involves exposing the polymer to high-energy radiation which causes the formation of free radicals within the polymer chains. These free radicals then initiate crosslinking reactions leading to the formation of a three-dimensional network within the polymer particles.

For example, in one embodiment, the high density polyethylene particles prior to grinding can be exposed to either x-rays or gamma rays from a radiation source. Both x-rays and gamma rays are forms of ionizing radiation that have sufficient energy to penetrate the material and induce chemical reactions within the polymer chains. When the radiation interacts with the polymer, it generates the free radicals within the polymer chains by breaking chemical bonds. These free radicals are highly reactive species with unpaired electrons.

The free radicals produced during radiation exposure initiate crosslinking reactions between neighboring polymer chains. This process involves the formation of covalent bonds between polymer molecules, leading to the creation of a three-dimensional network structure. After the desired level of crosslinking is achieved, optionally, the polymer particles may undergo post-treatment steps such as cooling or annealing.

The amount of radiation used to crosslink the high density polyethylene can vary. When using X-ray radiation or gamma radiation, for example, the polymer particles can be exposed to greater than about 100 kGy, such as greater than about 150 kGy, such as greater than about 180 kGy, such as greater than about 190 kGy, and less than about 500 kGy, such as less than about 300 kGy, such as less than about 250 kGy. When using gamma radiation, the polymer particles can be exposed to greater than about 100 kGy, such as greater than about 150 kGy, such as greater than about 180 kGy, such as greater than about 190 kGy, and less than about 500 kGy, such as less than about 300 kGy, such as less than about 250 kGy.

Crosslinking the high density polyethylene polymer causes the polymer to become more brittle, lowering the impact strength of the polymer. The increased brittleness or decreased impact strength makes the polymer particles more amenable to the grinding process. Consequently, at least partially crosslinking the high density polyethylene polymer prior to grinding can facilitate formation of smaller particles and/or increase the rate at which the particles are ground.

In addition or instead of crosslinking the high density polyethylene polymer, in another aspect, the high density polyethylene polymers can be ground in the presence of a grinding aid. The grinding aid, in one aspect, can comprise particles that have a hardness greater than the polyethylene polymer particles that collide with the particles during milling for generating smaller particles and/or increasing the grinding speed or rate. The grinding aid can also comprise a grinding lubricant.

Grinding aids are additives that are combined with the high density polyethylene polymer particles that are used to enhance the efficiency of the grinding process, typically by reducing the energy consumption required for size reduction and improving the flowability of the material being ground.

For instance, during jet milling, grinding aids can assist in the fragmentation of the high density polyethylene particles. The grinding aids can also help prevent the agglomeration of the high density polyethylene polymer particles during jet milling. This can lead to a more uniform particle size distribution and improve flow properties. Examples of grinding aids that may be used in accordance with the present disclosure include zircon particles, zirconium particles, quartz particles, or mixtures thereof. In one embodiment, the grinding aid can be water soluble. For example, one example of a water soluble grinding aid comprises sodium chloride particles. The grinding aids can have a (D50) particle size of from about 0.001 microns to about 100 microns. For example, the grinding aids can have a (D50) particle size of less than about 75 microns, such as less than about 50 microns, such as less than about 25 microns, such as less than about 10 microns, and greater than about 1 micron.

In another embodiment, the grinding aid can be a lubricant that also prevents agglomerations and improve milling efficiency by creating a greater amount of collisions during the process.

Grinding aids can be added during jet milling in an amount greater than about 3% by weight, such as in an amount greater than about 5% by weight, such as in an amount greater than about 10% by weight, such as in an amount greater than about 15% by weight, such as in an amount greater than about 20% by weight, such as in an amount greater than about 25% by weight, such as in an amount greater than about 30% by weight, such as in an amount greater than about 40% by weight, such as in an amount greater than about 50% by weight, and in an amount less than about 70% by weight, such as in an amount less than about 55% by weight, such as in an amount less than about 50% by weight, such as in an amount less than about 45% by weight, such as in an amount less than about 30% by weight.

Overall, the use of grinding aids during grinding or milling of the high density polyethylene particles can lead to significant improvements in process efficiency, particle size distribution, and material properties. In addition, depending on the particular type of grinding aid added, the grinding aid may also influence the morphology of the resulting particles. For instance, the grinding aid can control particle shape, surface roughness or other surface properties.

When one or more grinding aids are used, the grinding aids can be easily separated from the ground high density polyethylene particles. For instance, high density polyethylene particles typically have a density less than water and can be separated from many grinding aids using a flotation technique. Alternatively, as described above, a grinding aid can be used that is water soluble. In this embodiment, the ground high density polyethylene particles can be rinsed with water or placed in a water bath for dissolving and removing the grinding aid.

Through the process of the present disclosure, very small high density polyethylene particles as shown in FIG. 2 can be produced. The median particle size (D50) of the particles can be less than about 15 microns, such as less than about 14 microns, such as less than about 12 microns, such as less than about 10 microns, such as less than about 9 microns, such as less than about 8 microns, such as less than about 7 microns, and generally greater than about 2 microns, such as greater than about 4 microns.

As shown in FIG. 2, the resulting ground high density polyethylene particles can have irregular particle shapes. For instance, the particles can be non-spherical having a rough outer surface. Of particular advantage, the very small high density polyethylene polymer particles can have a relatively low bulk density. For instance, the bulk density can be less than about 0.38 g/cc, such as less than about 0.36 g/cc, such as less than about 0.34 g/cc, such as less than about 0.32 g/cc, such as less than about 0.3 g/cc, such as less than about 0.28 g/cc. The bulk density is generally greater than about 0.15 g/cc, such as greater than about 0.2 g/cc. The low bulk density is believed to provide numerous advantages and benefits. For instance, the low bulk density produces polymer particles that can easily be dispersed in other liquid and polymer systems, which can improve processing and handling. In this manner, molded articles can be produced having more uniform properties.

The high density polyethylene polymer contained in the ground high density polyethylene polymer particles can display a relatively high or low Shore D hardness and melting temperature. For instance, the Shore D hardness of the polymer contained in the particles can be less than about 63, such as less than about 61, such as less than about 60, and greater than about 50, such as greater than about 55, such as greater than about 58. Alternatively, the Shore D hardness of the polymer contained in the particles can be greater than about 63, such as greater than about 65, such as greater than about 68, and less than about 90. The melting temperature of the polymer contained within the particles can be less than about 135.5° C., such as less than about 135.1° C., and greater than about 130° C., such as greater than about 133° C., such as greater than about 134° C. Alternatively, the melting temperature of the polymer contained within the particles can be greater than about 136° C., such as greater than about 137°° C., and less than about 140° C.

As described above, the polymer micropowder of the present disclosure has many uses and applications. The polymer micropowder, for instance, can be used as an additive in a liquid or gel system. Alternatively, the polymer micropowder can be molded to form various articles, including sintered products. In still another aspect, the polymer micropowder can be used as a binder in ceramic or polymer systems.

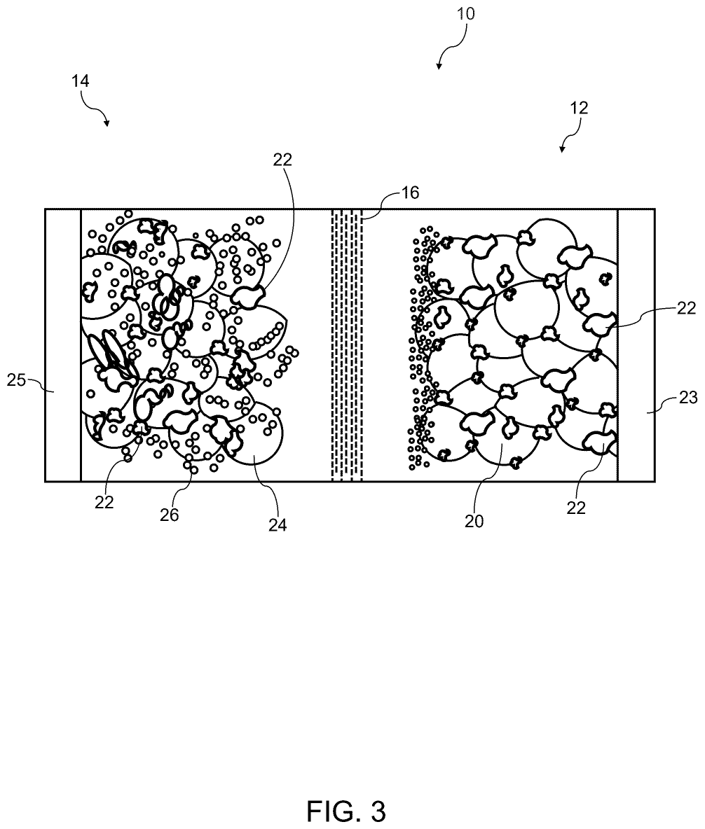

In one particular embodiment, the polymer micropowder of the present disclosure can be used to produce one or more components in an energy storage device, such as an ion battery. The ion battery can be, for instance, a lithium ion battery or a sodium ion battery. Referring to FIG. 3, for instance, a simplified figure of an energy storage device or battery 10 is illustrated. The battery 10 includes an anode 12 separated from a cathode 14 by a porous separator 16. The anode 12 is one of the electrodes in the battery 10 and can be made of a carbon material, such as graphite. During discharge, lithium ions move from the anode 12 to the cathode 14 through the separator 16.

The cathode 14 is the other electrode contained in the battery 10 and can comprise a lithium-containing metal oxide. The cathode 14 serves as a positive electrode during discharge.

The separator 16 is a thin, porous material placed between the anode 12 and the cathode 14 to physically separate the electrodes while allowing the flow of ions. The separator 16 prevents short circuits by preventing direct contact between the two electrodes. In one embodiment, the separator 16 can comprise a porous membrane made from the high density polyethylene polymer particles of the present disclosure. The high density polyethylene polymer, for instance, can be gel extruded into a porous membrane and incorporated into the battery 10. The high density polyethylene polymer particles can also be incorporated into the electrodes 12 and 14.

The anode 12, for instance, includes a network of an active material 20 held together by a binder 22 in accordance with the present disclosure. The active material, for instance, can comprise a carbon material while the binder 22 comprises the high density polyethylene polymer particles. The active material 20 and the binder 22 have been dry mixed together and formed into an electrode film under heat and pressure to form the anode 12. The anode 12 can further include a current collector 23. The electrode film made from the active material 20 and the binder 22 is laminated to the current collector 23. The current collector 23 facilitates flow of electrical current to and from the active material 20. For instance, the electrode film made from the active material 20 and the binder 22 is porous in nature. The current collector 23 serves as the substrate that can efficiently conduct electricity. When a voltage is applied to the electrode, electrons flow through the current collector, allowing the electrode to deliver or accept electrical charge. In one embodiment, the current collector 23 for the anode 12 can comprise a metal foil, such as a copper foil.

The cathode 14 also includes an active material 24 held together by the binder 22. The active material 24 in a cathode 14 may comprise, for instance, a lithium-containing material, such as a lithium-containing metal oxide or a sodium-containing material. As shown, the cathode 14 can also include an additive 26. The additive 26, for instance, may comprise a conductive additive to improve the electrical conductivity of the cathode 14. The additive 26 can also comprise a salt, a dopant, or an electrolyte additive.

The cathode 14 also includes a current collector 25 comprising a metal foil. For instance, the current collector 25 may comprise an aluminum foil.

The battery 10 as shown in FIG. 3 can also include an electrolyte. The electrolyte is a chemical compound that allows for the flow of lithium ions between the anode 12 and the cathode 14 while preventing direct electrical contact between the electrodes. The electrolyte, for instance, can comprise a lithium or sodium salt dissolved in a solvent, such as a lithium hexafluorophosphate dissolved in a solvent like ethylene carbonate and/or dimethyl carbonate.

The battery 10, as shown in FIG. 3, can further include an enclosure or housing for protecting the components including the electrodes. The housing can be made from a metal or a plastic. Further, the battery 10 can include terminals on the outside of the casing or housing which are used to connect the battery to external devices or charging equipment. The battery 10 can also include a vent to prevent overcharging, over-discharging, and overheating. The vent, for instance, can comprise a passageway that allows gas to escape in the event of over pressure or thermal runaway.

Whether constructing the anode 12 or the cathode 14, a binder is used in order to hold together the active material for forming an electrode film that can then be laminated to the current collector. In accordance with the present disclosure, the binder 22 comprises high density polyethylene polymer particles in the form of a polymer micropowder.

The high density polyethylene polymer used to form the polymer micropowder of the present disclosure can generally have a density of about 0.92 g/cm³ or greater, such as about 0.93 g/cm³ or greater, such as about 0.94 g/cm³ or greater, and generally less than about 1 g/cm^{3,} such as less than about 0.97 g/cm3.

The high density polyethylene polymer can be made from over 90% ethylene derived units, such as greater than 95% ethylene derived units, or from 100% ethylene derived units. The polyethylene can be a homopolymer or a copolymer, including a terpolymer, having other monomeric units.

The high density polyethylene can be a high molecular weight polyethylene, a very high molecular weight polyethylene, and/or an ultrahigh molecular weight polyethylene. “High molecular weight polyethylene” refers to polyethylene compositions with an average molecular weight of at least about 3×10⁵ g/mol and, as used herein, is intended to include very-high molecular weight polyethylene and ultra-high molecular weight polyethylene. For purposes of the present specification, the molecular weights referenced herein are determined in accordance with the Margolies equation (“Margolies molecular weight”).

“Very-high molecular weight polyethylene” refers to polyethylene compositions with a weight average molecular weight of less than about 3×10⁶ g/mol and more than about 1×10⁶ g/mol. In some embodiments, the molecular weight of the very-high molecular weight polyethylene composition is between about 2×10⁶ g/mol and less than about 3×10⁶ g/mol.

“Ultra-high molecular weight polyethylene” refers to polyethylene compositions with an average molecular weight of at least about 3×10⁶ g/mol. In some embodiments, the molecular weight of the ultra-high molecular weight polyethylene composition is between about 3×10⁶ g/mol and about 30×10⁶ g/mol, or between about 3×10⁶ g/mol and about 20×10⁶ g/mol, or between about 3×10⁶ g/mol and about 10×10⁶ g/mol, or between about 3×10⁶ g/mol and about 6×10⁶ g/mol.

In one aspect, the high density polyethylene is a homopolymer of ethylene. In another embodiment, the high density polyethylene may be a copolymer. For instance, the high density polyethylene may be a copolymer of ethylene and another olefin containing from 3 to 16 carbon atoms, such as from 3 to 10 carbon atoms, such as from 3 to 8 carbon atoms. These other olefins include, but are not limited to, propylene, 1-butene, 1-pentene, 1-hexene, 1-heptene, 1-octene, 4-methylpent-1-ene, 1-decene, 1-dodecene, 1-hexadecene and the like. Also utilizable herein are polyene comonomers such as 1,3-hexadiene, 1,4-hexadiene, cyclopentadiene, dicyclopentadiene, 4-vinylcyclohex-1-ene, 1,5-cyclooctadiene, 5-vinylidene-2-norbornene and 5-vinyl-2-norbornene. However, when present, the amount of the non-ethylene monomer(s) in the copolymer may be less than about 10 mol. %, such as less than about 5 mol. %, such as less than about 2.5 mol. %, such as less than about 1 mol. %, wherein the mol. % is based on the total moles of monomer in the polymer.

In one embodiment, the high density polyethylene may have a monomodal molecular weight distribution. Alternatively, the high density polyethylene may exhibit a bimodal molecular weight distribution. For instance, a bimodal distribution generally refers to a polymer having a distinct higher molecular weight and a distinct lower molecular weight (e.g. two distinct peaks) on a size exclusion chromatography or gel permeation chromatography curve. In another embodiment, the high density polyethylene may exhibit more than two molecular weight distribution peaks such that the polyethylene exhibits a multimodal (e.g., trimodal, tetramodal, etc.) distribution. Alternatively, the high density polyethylene may exhibit a broad molecular weight distribution wherein the polyethylene is comprised of a blend of higher and lower molecular weight components such that the size exclusion chromatography or gel permeation chromatography curve does not exhibit at least two distinct peaks but instead exhibits one distinct peak broader than the individual component peaks.

The molecular weight of the high density polyethylene polymer, for instance, can generally be greater than about 300,000 g/mol, such as greater than about 400,000 g/mol, such as greater than about 500,000 g/mol, such as greater than about 650,000 g/mol, such as greater than about 800,000 g/mol, such as greater than about 1,250,000 g/mol, such as greater than about 1,500,000 g/mol, such as greater than about 1,750,000 g/mol, such as greater than about 2,000,000 g/mol, such as greater than about 2,250,000 g/mol, such as greater than about 2,500,000 g/mol, such as greater than about 2,750,000 g/mol, such as greater than about 3,000,000 g/mol, such as greater than about 3,250,000 g/mol, such as greater than about 3,500,000 g/mol. The molecular weight of the one or more polyethylene polymers is generally less than about 13,000,000 g/mol, such as less than about 11,000,000 g/mol, such as less than about 10,000,000 g/mol, such as less than about 8,000,000 g/mol, such as less than about 6,000,000 g/mol, such as less than about 4,500,000 g/mol, such as less than about 3,500,000 g/mol, such as less than about 3,000,000 g/mol, such as less than about 2,500,000 g/mol. The crystallinity can be greater than about 40%, such as greater than about 50%, such as greater than about 55%, and less than about 70%, such as less than about 65%.

Any method known in the art can be utilized to synthesize the initial high density polyethylene polymer particles, including the polyethylene particles having the multilobal shape. The polyethylene powder is typically produced by the catalytic polymerization of ethylene monomer or optionally with one or more other 1-olefin co-monomers, the 1-olefin content in the final polymer being less or equal to 10% of the ethylene content, with a heterogeneous catalyst and an organo aluminum or magnesium compound as cocatalyst. The ethylene is usually polymerized in gaseous phase or slurry phase at relatively low temperatures and pressures. The polymerization reaction may be carried out at a temperature of between 50° C. and 100° C. and pressures in the range of 0.02 and 2 MPa.

The molecular weight of the polyethylene can be adjusted by adding hydrogen. Altering the temperature and/or the type and concentration of the co-catalystmay also be used to fine tune the molecular weight. Additionally, the reaction may occur in the presence of antistatic agents to avoid wall fouling and product contamination.

Suitable catalyst systems include but are not limited to Ziegler-Natta type catalysts and/or metallocene catalysts. Typically Ziegler-Natta type catalysts are derived by a combination of transition metal compounds of Groups 4 to 8 of the Periodic Table and alkyl or hydride derivatives of metals from Groups 1 to 3 of the Periodic Table. Transition metal derivatives used usually comprise the metal halides or esters or combinations thereof. Exemplary Ziegler-Natta catalysts include those based on the reaction products of organo aluminum or magnesium compounds, such as for example but not limited to aluminum or magnesium alkyls and titanium, vanadium or chromium halides or esters. The heterogeneous catalyst might be either unsupported or supported on porous fine grained materials, such as silica or magnesium chloride. Such support can be added during synthesis of the catalyst or may be obtained as a chemical reaction product of the catalyst synthesis itself.

In one embodiment, a suitable catalyst system could be obtained by the reaction of a titanium (IV) compound with a trialkyl aluminum compound in an inert organic solvent at temperatures in the range of −40° C. to 100° C., preferably −20° C. to 50° C. The concentrations of the starting materials are in the range of 0.1 to 9 mol/L, preferably 0.2 to 5 mol/L, for the titanium (IV) compound and in the range of 0.01 to 1 mol/L, preferably 0.02 to 0.2 mol/L for the trialkyl aluminum compound. The titanium component is added to the aluminum component over a period of 0.1 min to 60 min, preferably 1 min to 30 min, the molar ratio of titanium and aluminum in the final mixture being in the range of 1:0.01 to 1:4.

In another embodiment, a suitable catalyst system is obtained by a one or two-step reaction of a titanium (IV) compound with a trialkyl aluminum compound in an inert organic solvent at temperatures in the range of −40° C. to 200° C., preferably −20° C. to 150° C. In the first step, the titanium (IV) compound is reacted with the trialkyl aluminum compound at temperatures in the range of −40° C. to 100° C., preferably −20° C. to 50° C. using a molar ratio of titanium to aluminum in the range of 1:0.1 to 1:0.8. The concentrations of the starting materials are in the range of 0.1 to 9.1 mol/L, preferably 5 to 9.1 mol/L, for the titanium (IV) compound and in the range of 0.05 and 1 mol/L, preferably 0.1 to 0.9 mol/L for the trialkyl aluminum compound. The titanium component is added to the aluminum compound over a period of 0.1 min to 800 min, preferably 30 min to 600 min. In a second step, if applied, the reaction product obtained in the first step is treated with a trialkyl aluminum compound at temperatures in the range of −10°° C. to 150° C., preferably 10° C. to 130° C. using a molar ratio of titanium to aluminum in the range of 1:0.01 to 1:5.

In yet another embodiment, a suitable catalyst system is obtained by a procedure wherein, in a first reaction stage, a magnesium alcoholate is reacted with a titanium chloride in an inert hydrocarbon at a temperature of 50° to 100° C. In a second reaction stage, the reaction mixture formed is subjected to heat treatment for a period of about 10 to 100 hours at a temperature of 110° to 200° C. accompanied by evolution of alkyl chloride until no further alkyl chloride is evolved, and the solid is then freed from soluble reaction products by washing several times with a hydrocarbon.

In a further embodiment, catalysts supported on silica, such as for example the commercially available catalyst system Sylopol 5917 can also be used.

In one embodiment, especially when producing a relatively high molecular weight polyethylene, a metallocene-type catalyst may be used. For example, in one embodiment, two different metallocene-type catalysts can be used to produce the polyethylene polymer. For instance, the metallocene catalysts may be made from metals, such as hafnium and/or chromium.

Using such catalyst systems, the polymerization is normally carried out in suspension at low pressure and temperature in one or multiple steps, continuous or batch. The polymerization temperature is typically in the range of 30° C. to 130° C., preferably in the range of 50° C. and 90° C. and the ethylene partial pressure is typically less than 10 MPa, preferably 0.05 and 5 MPa. Trialkyl aluminums, like for example but not limited to isoprenyl aluminum and triisobutyl aluminum, are used as co-catalyst such that the ratio of Al:Ti (co-catalyst versus catalyst) is in the range of 0.01 to 100:1, more preferably in the range of 0.03 to 50:1. The solvent is an inert organic solvent as typically used for Ziegler type polymerizations. Examples are butane, pentane, hexane, cyclohexene, octane, nonane, decane, their isomers and mixtures thereof. The polymer molecular mass is controlled through feeding hydrogen. The ratio of hydrogen partial pressure to ethylene partial pressure is in the range of 0 to 50, preferably the range of 0 to 10. The polymer is isolated and dried in a fluidized bed dryer under nitrogen. The solvent may be removed through steam distillation in case of using high boiling solvents. Salts of long chain fatty acids may be added as a stabilizer. Typical examples are calcium-magnesium and zinc stearate.

Generally a cocatalyst such as alumoxane or alkyl aluminum or alkyl magnesium compound is also employed. Other suitable catalyst systems include Group 4 metal complexes of phenolate ether ligands.

After the high density polyethylene polymer particles are formed, the particles are ground to form the polymer micropowder of the present disclosure. The polymer micropowder, as described above, can then be used to produce various components of the battery 10 as shown in FIG. 3. The polymer micropowder, for instance, can be used as a binder in one of the electrodes and/or can be used to produce the separator 16.

When used as a binder to produce an electrode film, the binder can be incorporated into the electrode film in an amount from about 0.01% by weight to about 15% by weight including all increments of 0.1% by weight therebetween. For instance, the binder particles can be incorporated into the electrode film in an amount greater than about 0.3% by weight, such as in an amount greater than about 0.5% by weight, such as in an amount greater than about 0.8% by weight, such as in an amount greater than about 1% by weight, such as in an amount greater than about 1.2% by weight, such as in an amount greater than about 1.5% by weight, such as in an amount greater than about 1.7% by weight, such as in an amount greater than about 2% by weight, such as in an amount greater than about 2.2% by weight. The binder particles are generally incorporated into the electrode film in an amount less than about 10% by weight, such as in an amount less than about 8% by weight, such as in an amount less than about 6% by weight, such as in an amount less than about 4% by weight, such as in an amount less than about 3.5% by weight, such as in an amount less than about 3% by weight.

The binder can be made exclusively or only from the high density polyethylene particles. Alternatively, the binder can comprise the high density polyethylene particles combined with fluoropolymer particles, such as polytetrafluoroethylene particles. The fluoropolymer particles, such as PTFE particles, can be present in the binder in an amount of from about 0.1% by weight to about 99.9% by weight, such as from about 2% by weight to about 40% by weight, such as from about 5% by weight to about 25% by weight.

The particles are combined with an active material and possibly other auxiliary agents and formed into an electrode film. In one aspect, the film can be a solventless film meaning that the film is formed without using a solvent. A solventless film, for instance, contains no processing solvents or processing solvent residues. The film, however, may contain atmospheric moisture.

In order to form the electrode film, in one embodiment, the binder particles can be combined with active material particles and first dry mixed together. After dry mixing, the particles can be subjected to heat and pressure sufficient to form a film. Heat and pressure is applied to the mixture in order for the binder particles or high density polyethylene polymer particles to flow and form an interconnected network of the active material. The resulting electrode film can be freestanding and is then laminated to a current collector, such as a metal foil.

As described above, the binder particles of the present disclosure can be used to produce anodes or cathodes. Consequently, the active material that is combined with the binder can vary depending upon the particular application. Anode active materials can comprise, for example, an insertion material (such as carbon, graphite, and/or graphene), an alloying/dealloying material (such as silicon, silicon oxide, tin, and/or tin oxide), a metal alloy or compound (such as Si—Al, and/or Si—Sn), and/or a conversion material (such as manganese oxide, molybdenum oxide, nickel oxide, and/or copper oxide). The anode active materials can be used alone or mixed together to form multi-phase materials (such as Si—C, Sn—C, SiOx-C, SnOx-C, Si—Sn, Si—SiOx, S—SnOx, Si—SiOx-C, Sn—SnOx-C, Si—Sn—C, SiOx-SnOx-C, Si—SiOx-Sn, or Sn—SiOx-SnOx.).

The active material particles can be present in the electrode film in an amount from about 40% by weight to about 99.5% by weight, including all increments of 0.5% by weight therebetween. For instance, the active material contained in the electrode film to produce an anode, which can be graphite in one embodiment, can be present in the electrode film in an amount greater than about 60% by weight, such as in an amount greater than about 70% by weight, such as in an amount greater than about 80% by weight, such as in an amount greater than about 90% by weight, such as in an amount greater than about 93% by weight, such as in an amount greater than about 95% by weight.

In addition to the active material and binder, the anode film made in accordance with the present disclosure can also contain a conductive additive. The conductive additive may comprise from about 0.01% by weight to about 5% by weight of the electrode film. For instance, the conductive additive can be present in the electrode film in an amount greater than about 0.3% by weight, such as in an amount greater than about 0.8% by weight, such as in an amount greater than about 1% by weight, such as in an amount greater than about 1.2% by weight, and in an amount less than about 5% by weight, such as in an amount less than about 3% by weight. The electrode film used to form an anode may also contain various other additives.

When producing electrode films for constructing cathodes, the cathode active material can include a sodium salt lithium metal oxide and/or a lithium sulfide. In some embodiments, the cathode active material may include lithium nickel manganese cobalt oxide (NMC), lithium manganese oxide (LMO), lithium iron phosphate (LFP), lithium cobalt oxide (LCO), lithium nickel manganese oxide and/or lithium nickel cobalt aluminum oxide (NCA). The cathode active material can comprise sulfur or a material including sulfur, such as lithium sulfide (Li₂S), or other sulfur-based materials, or a mixture thereof. In some embodiments, the cathode film comprises a sulfur or a material including sulfur active material at a concentration of at least 50 wt %. In some embodiments, the cathode film comprising a sulfur or a material including sulfur active material has an areal capacity of at least 10 mAh/cm². In some embodiments, the cathode film comprising a sulfur or a material including sulfur active material has an electrode film density of 1 g/cm³. In some embodiments, the cathode film comprising a sulfur or a material including sulfur active material further comprises a binder.

One or more active materials can be contained in a cathode film in an amount from about 50% by weight to about 99.5% by weight, including all increments of 0.1% by weight therebetween. For instance, one or more active materials can be contained in the cathode film in an amount greater than about 60% by weight, such as in an amount greater than about 70% by weight, such as in an amount greater than about 80% by weight, such as in an amount greater than about 90% by weight, such as in an amount greater than about 93% by weight, such as in an amount greater than about 95% by weight.

Similar to the anode, the cathode film can also contain a conductive additive comprising any of the carbon materials described above in the amounts described above. The cathode film may also contain a dopant, such as aluminum, nickel, or titanium, a lithium salt, or an electrolyte additive.

One embodiment of a process 50 for producing electrode films in accordance with the present disclosure is illustrated in FIG. 3. As shown, the high molecular weight polyethylene polymer binder particles are combined with active material particles and optionally with other additives and fed to a hopper 52. From the hopper 52, the dry mixture is blended in the mixer 54. When mixing the components together, no liquid solvents are used. The mixer can be any suitable mixer, such as a tumbler mixer, a motorized blender, or can be combined through shaking. In one embodiment, the binder and active material can be fed through a dry milling step together in order to create a homogeneous mixture and control particle size.

After being mixed, the dry mixture is subjected to heat and pressure that causes a porous film to be produced. In particular, heat and pressure are applied causing the binder particles to flow and attach together the active material particles. In this manner, a porous matrix of the active material is formed.

As shown in FIG. 3, in one embodiment, the dry mixture is fed to a calendering device 56 that comprises a pair of opposing compression rolls. One or more of the rolls can be heated. The calendering device 56 forms a nip and the dry mix of materials can be subjected to a temperature of from about 70° C. to about 250° C. For instance, the temperature within the nip can be greater than about 100° C., such as greater than about 125° C., such as greater than about 150° C., such as greater than about 175° C., such as greater than about 185° C., such as greater than about 200° C., such as greater than about 205° C., such as greater than about 210°° C., and less than about 240° C., such as less than about 220° C. The pressure applied within the nip can be greater than about 0.1 MPa, such as greater than about 0.5 MPa, such as greater than about 1 MPa, such as greater than about 2 MPa, such as greater than about 3 MPa, such as greater than about 4 MPa, such as greater than about 5 MPa, and less than about 10 MPa, such as less than about 9 MPa, such as less than about 8 MPa, such as less than about 7 MPa, such as less than about 6 MPa.

In one embodiment, the formed sheet or film is subjected to active cooling. For instance, the electrode film 57, as shown in FIG. 3, can be cooled to less than about 100° C., such as less than about 80° C., in less than about 10 mins., such as less than about 8 mins., such as less than about 5 mins.

Once the electrode film 57 is formed, the film is then fed to a laminating device 58 and laminated to a current collector 60, such as a metal foil. The laminating device may apply heat and pressure sufficient to cause the electrode film 57 to adhere to the current collector 60. In one embodiment, an adhesive or tie layer may be present on the current collector 60 for facilitating the formation of a bond between the two materials.

Once the electrode film 57 is laminated to the current collector 60, the resulting laminate can be wound into a roll 62. Later, the laminate can be unwound, cut into strips, and fed into a process for producing energy storage devices, such as lithium ion batteries.

The basis weight of the electrode film 57 on the current collector 60 can vary depending upon the particular application. The basis weight of electrode film is generally greater than about 10 gsm, such as greater than about 20 gsm, such as greater than about 30 gsm, such as greater than about 40 gsm, such as greater than about 50 gsm, such as greater than about 60 gsm, such as greater than about 70 gsm, such as greater than about 80 gsm, such as greater than about 90 gsm, such as greater than about 100 gsm, such as greater than about 110 gsm, such as greater than about 120 gsm, such as greater than about 130 gsm, such as greater than about 140 gsm, such as greater than about 150 gsm, such as greater than about 160 gsm, such as greater than about 170 gsm, such as greater than about 180 gsm, such as greater than about 190 gsm, such as greater than about 200 gsm. The basis weight is generally less than about 500 gsm, such as less than about 450 gsm, such as less than about 400 gsm, such as less than about 350 gsm, such as less than about 300 gsm, such as less than about 275 gsm, such as less than about 250 gsm, such as less than about 225 gsm, such as less than about 200 gsm, such as less than about 175 gsm, such as less than about 150 gsm, such as less than about 125 gsm.

When incorporated into an energy storage device, such as a lithium ion battery, as described above, the anode and cathode are separated by a porous membrane or separator. In one aspect, the separator can comprise a porous membrane also made from the very high or an ultrahigh molecular weight polyethylene polymer particles of the present disclosure.

In forming porous polymer films in accordance with the present disclosure, the high density polyethylene particles can be combined with a plasticizer and then gel extruded.

When combined with a plasticizer in forming porous films or membranes, the high density polyethylene particles are present in the polymer composition in an amount up to about 50% by weight. For instance, the high density polyethylene particles can be present in the polymer composition in an amount less than about 45% by weight, such as in an amount less than about 40% by weight, such as in an amount less than about 35% by weight, such as in an amount less than about 30% by weight, such as in an amount less than about 25% by weight, such as in an amount less than about 20% by weight, such as in an amount less than about 15% by weight. The polyethylene particles can be present in the composition in an amount greater than about 5% by weight, such as in an amount greater than about 10% by weight, such as in an amount greater than about 15% by weight, such as in an amount greater than about 20% by weight, such as in an amount greater than about 25% by weight.

During gel processing, a plasticizer is combined with the high density polyethylene particles which can be substantially or completely removed in forming polymer articles. For example, in one embodiment, the resulting polymer article can contain the high density polyethylene polymer in an amount greater than about 50% by weight, such as in an amount greater than about 60% by weight, such as in an amount greater than about 65% by weight, such as in an amount greater than about 70% by weight, such as in an amount greater than about 75% by weight, such as in an amount greater than about 80% by weight, such as in an amount greater than about 85% by weight, such as in an amount greater than about 90% by weight, such as in an amount greater than about 95% by weight, such as in an amount greater than about 98% by weight, such as in an amount greater than about 99% by weight, such as in an amount greater than about 99.5% by weight.

The plasticizer, for instance, may comprise a hydrocarbon oil, an alcohol, an ether, an ester such as a diester, or mixtures thereof. For instance, suitable plasticizers include mineral oil, a paraffinic oil, decaline, and the like. Other plasticizers include xylene, dioctyl phthalate, dibutyl phthalate, stearyl alcohol, oleyl alcohol, decyl alcohol, nonyl alcohol, diphenyl ether, n-decane, n-dodecane, octane, nonane, kerosene, toluene, naphthalene, tetraline, and the like. In one embodiment, the plasticizer may comprise a halogenated hydrocarbon, such as monochlorobenzene. Cycloalkanes and cycloalkenes may also be used, such as camphene, methane, dipentene, methylcyclopentandiene, tricyclodecane, 1,2,4,5-tetramethyl-1,4-cyclohexadiene, and the like. The plasticizer may comprise mixtures and combinations of any of the above as well.

The plasticizer is generally present in the composition used to form the polymer articles in an amount greater than about 50% by weight, such as in an amount greater than about 55% by weight, such as in an amount greater than about 60% by weight, such as in an amount greater than about 65% by weight, such as in an amount greater than about 70% by weight, such as in an amount greater than about 75% by weight, such as in an amount greater than about 80% by weight, such as in an amount greater than about 85% by weight, such as in an amount greater than about 90% by weight, such as in an amount greater than about 95% by weight, such as in an amount greater than about 98% by weight. In fact, the plasticizer can be present in an amount up to about 99.5% by weight.

The high density polyethylene particles blend with the plasticizer to form a homogeneous gel-like material.

In order to form polymer articles in accordance with the present disclosure, the high density polyethylene particles are combined with the plasticizer and extruded through a die of a desired shape. In one embodiment, the composition can be heated within the extruder. For example, the plasticizer can be combined with the particle mixture and fed into an extruder. In accordance with the present disclosure, the plasticizer and particle mixture form a homogeneous gel-like material prior to leaving the extruder for forming polymer articles with little to no impurities.

In one embodiment, elongated articles, such as porous films, are formed during the gel spinning or extruding process and used as a separator in a battery.

During the process, at least a portion of the plasticizer is removed from the final product. The plasticizer removal process may occur due to evaporation when a relatively volatile plasticizer is used. Otherwise, an extraction liquid can be used to remove the plasticizer. The extraction liquid may comprise, for instance, a hydrocarbon solvent. One example of the extraction liquid, for instance, is dichloromethane. Other extraction liquids include acetone, chloroform, an alkane, hexene, heptene, an alcohol, or mixtures thereof.

If desired, the resulting polymer article can be stretched at an elevated temperature below the melting point of the polyethylene polymer to increase strength and modulus. Suitable temperatures for stretching are in the range of from about ambient temperature to about 155° C. The draw ratios can generally be greater than about 4, such as greater than about 6, such as greater than about 8, such as greater than about 10, such as greater than about 15, such as greater than about 20, such as greater than about 25, such as greater than about 30. In certain embodiments, the draw ratio can be greater than about 50,such as greater than about 100, such as greater than about 110, such as greater than about 120, such as greater than about 130, such as greater than about 140, such as greater than about 150. Draw ratios are generally less than about 1,000, such as less than about 800, such as less than about 600, such as less than about 400. In one embodiment, lower draw ratios are used such as from about 4 to about 10. The polymer article can be uniaxially stretched or biaxially stretched.

Porous membranes made according to the present disclosure have sufficient strength such that they can be incorporated into an energy storage device, such as a battery, as a single layer polymer membrane. The single layer polymer membrane, however, may also include a coating. The coating can be an inorganic coating made from, for instance, aluminum oxide or a titanium oxide. Alternatively, the single layer polymer membrane may also include a polymeric coating. The coating can provide increased thermal resistance.

Porous membranes or films made according to the present disclosure can generally have a thickness of greater than about 3 microns, such as greater than about 4 microns, such as greater than about 5 microns, such as greater than about 6 microns, such as greater than about 7 microns, such as greater than about 8 microns, such as greater than about 9 microns. The thickness of the membranes or films is generally less than about 25 microns, such as less than about 16 microns, such as less than about 14 microns, such as less than about 12 microns, such as less than about 10 microns, such as less than about 8 microns.

Membranes or films made according to the present disclosure can have excellent physical properties. For example, membranes or films having a porosity of from about 25% to about 60%, such as from about 35% to about 55%, can have a puncture strength of greater than about 800 mN/micron, such as greater than about 1,200 mN/micron, such as greater than about 1,400 mN/micron, such as greater than about 1,475 mN/micron, such as greater than about 1,500 mN/micron, such as greater than about 1,525 mN/micron, such as greater than about 1,550 mN/micron, such as greater than about 1,575 mN/micron, such as greater than about 1,600 mN/micron, such as greater than about 1,625 mN/micron, such as greater than about 1,650 mN/micron, and generally less than about 3,000 mN/micron. The pin strength can be greater than about 200 gf/g/cm², such as greater than about 250 gf/g/cm², such as greater than about 252 gf/g/cm², such as greater than about 254 gf/g/cm², such as greater than about 256 gf/g/cm², such as greater than about 258 gf/g/cm², such as greater than about 260 gf/g/cm², such as greater than about 262 gf/g/cm², and generally less than about 300 gf/g/cm².

At a membrane or film porosity of from about 39% to about 50%, the membrane or film can have a puncture strength of greater than about 300 mN/micron, such as greater than about 340 mN/micron, such as greater than about 350 mN/micron, such as greater than about 360 mN/micron, such as greater than about 370 mN/micron, such as greater than about 380 mN/micron, such as greater than about 390 mN/micron, such as greater than about 400 mN/micron, and generally less than about 600 mN/micron and can have a pin strength of greater than about 60 gf/g/cm², such as greater than about 65 gf/g/cm², such as greater than about 72 gf/g/cm², such as greater than about 74 gf/g/cm², such as greater than about 76 gf/g/cm², such as greater than about 78 gf/g/cm², such as greater than about 80 gf/g/cm², such as greater than about 82 gf/g/cm², and generally less than about 150 gf/g/cm².

Membranes or films made according to the present disclosure can also have excellent tensile strength properties in either the machine direction or the cross-machine direction. For instance, in either direction, the membrane or film can have a tensile strength of greater than about 100 MPa, such as greater than about 125 MPa, such as greater than about 140 MPa, such as greater than about 150 MPa, such as greater than about 160 MPa, such as greater than about 162 MPa, such as greater than about 164 MPa, such as greater than about 166 MPa, such as greater than about 168 MPa, such as greater than about 170 MPa, and generally less than about 250 MPa.

Polymer membranes or films made according to the present disclosure can have a Gurley permeability of greater than about 50 sec/100 mL, such as greater than about 70 sec/100 mL, such as greater than about 105 sec/100 mL, such as greater than about 150 sec/100 mL, such as greater than about 200 sec/100 mL, such as greater than about 225 sec/100 mL, such as greater than about 250 sec/100 mL, such as greater than about 275 sec/100 mL, such as greater than about 300 sec/100 mL, such as greater than about 325 sec/100 mL, such as greater than about 350 sec/100 mL, such as greater than about 375 sec/100 mL, such as greater than about 400 sec/100 mL, such as greater than about 425 sec/100 mL, such as greater than about 450 sec/100 mL, such as greater than about 475 sec/100 mL, such as greater than about 500 sec/100 mL, such as greater than about 525 sec/100 mL, such as greater than about 550 sec/100 mL, such as greater than about 575 sec/100 mL, such as greater than about 600 sec/100 mL, and generally less than about 1,000 sec/100 mL.

An electrolyte is also contained within the energy storage device and is in contact with the anode, with the cathode, and with the separator. When the anode, cathode, and separator all contain a high density polyethylene polymer, an electrolyte can be selected that is compatible with the polymer for producing efficiencies not only in terms of mechanical properties but also in terms of electrical properties.

In one embodiment, present battery uses a suitable lithium-containing electrolyte. For example, a lithium salt, and a solvent, such as a non-aqueous or organic solvent, or fluorinated organic solvent. Generally, the lithium salt includes an anion that is redox stable. In some embodiments, the anion can be monovalent. In some embodiments, a lithium salt can be selected from hexafluorophosphate (LiPFe), lithium tetrafluoroborate (LiBF4), lithium perchlorate (LiCIC), lithium bis (trifluoromethansulfonyl) imide (LiN (SO2CFs)2), lithium trifluoromethansulfonate (USO3CF3), lithium bis (oxalate) borate (LiBOB) and combinations thereof. In some embodiments, the electrolyte can include a quaternary ammonium cation and an anion selected from the group consisting of hexafluorophosphate, tetrafluoroborate and iodide. In some embodiments, the salt concentration can be about 0.1 mol/L (M) to about 5 M, about 0.2 M to about 3 M, or about 0.3 M to about 2 M. In further embodiments, the salt concentration of the electrolyte can be about 0.7 M to about 1 M. In certain embodiments, the salt concentration of the electrolyte can be about 0.2 M, about 0.3 M, about 0.4 M, about 0.5 M, about 0.6 M, about 0.7 M, about 0.8 M, about 0.9 M, about 1 M, about M, about 1.2 M, or any range of values therebetween.

In some embodiments, electrolytes of the present high voltage lithium-ion secondary battery invention include a liquid solvent. In further embodiments, the solvent can be an organic solvent. In some embodiments, a solvent can include one or more functional groups selected from carbonates, ethers and/or esters. In some embodiments, the solvent can comprise a carbonate. In further embodiments, the carbonate can be selected from cyclic carbonates such as, for example, ethylene carbonate (EC), propylene carbonate (PC), vinyl ethylene carbonate (VEC), vinylene carbonate (VC), fluoroethylene carbonate (FEC), methyl (2,2,2-trifluoroethyl) carbonate (FEMC) and combinations thereof, or acyclic carbonates such as, for example, dimethyl carbonate (DMC), diethyl carbonate (DEC), ethyl methyl carbonate (EMC), and combinations thereof. In certain embodiments, the electrolyte can comprise Li PF6, and one or more carbonates. An example organic solvent electrolyte includes the electrolyte known in this field as “Gen 2” electrolyte, which is 1.0 M LiPFe in ethylene carbonate (EC) and ethylmethyl carbonate (EMC), EC: EMC ratio of 3:7 by weight. In a preferred embodiment, electrolyte for use in the present high voltage lithium-ion secondary battery invention is the fluorinated organic solvent electrolyte. For example, fluorinated electrolyte referred to as FEC-FEMC, which is 1 M LiPFe in fluoroethylene carbonate (FEC) and methyl (2,2,2-trifluoroethyl) carbonate (FEMC), having an FEC: FEMC ratio of 1:9 by volume.

In an alternative embodiment, the high density polyethylene particles of the present disclosure can be used to produce sintered products, such as pipette tips, biomedical filters and other porous substrates.

For instance, the resulting granular product of the present disclosure can be used to form porous articles through a sintering process. Porous articles may be formed by a free sintering process which involves introducing the polyethylene polymer powder described above into either a partially or totally confined space, e.g., a mold, and subjecting the molding powder to heat sufficient to cause the polyethylene particles to soften, expand and contact one another. Suitable processes include compression molding and casting. The mold can be made of steel, aluminum or other metals.

The mold can be heated in a convection oven, hydraulic press or infrared heater to a sintering temperature between about 140° C. and about 300° C., such as between about 160° C. and about 300° C., for example between about 170° C. and about 240° C. to sinter the polymer particles. The heating time and temperature vary and depend upon the mass of the mold and the geometry of the molded article. However, the heating time typically lies within the range of about 25 to about 100 minutes. During sintering, the surface of individual polymer particles fuse at their contact points forming a porous structure. Subsequently, the mold is cooled and the porous article removed. In general, a molding pressure is not required. However, in cases requiring porosity adjustment, a proportional low pressure can be applied to the powder.

Porous substrates made according to the present disclosure can have a porosity of greater than about 20%, such as greater than about 35%, such as greater than about 40%. The porosity is generally less than about 80%, such as less than about 60%, such as less than about 55%. Porosity can be determined according to DIN Test 66133. Average pore size which can also be determined according to Test DIN 66133 can generally be less than about 180 microns, such as less than about 150 microns, such as less than about 110 microns, such as less than about 90 microns, and greater than about 20 microns.

Porous substrates made according to the present disclosure can be used in numerous and diverse applications. Specific examples include wastewater aeration, capillary applications and filtration.

Capillary applications of the present porous sintered articles include writing instruments, such as highlighters, color sketch pens, permanent markers and erasable whiteboard markers. These make use of the capillary action of a porous nib to transport ink from a reservoir to a writing surface. Currently, porous nibs formed from ultra-high molecular weight polyethylene are frequently used for highlighters and color sketch pens, whereas permanent and whiteboard markers are generally produced from by polyester (polyethylene terephthalate), polyolefin hollow fibers and acrylic porous materials. The large pore size of the present sintered articles make them attractive for use in the capillary transport of the alcohol-based high-viscosity inks employed in permanent markers and white board markers.

Other filtration applications of the present porous sintered articles include medical fluid filtration, such as filtration of blood outside the human body, filtration to remove solids in chemical and pharmaceutical manufacturing processes, and filtration of hydraulic fluids to remove solid contaminants.

The present disclosure may be better understood with reference to the following examples.

### Example No. 1

Multilobal polyethylene particles commercially available from Celanese International of Dallas, Texas, were fed through a grinding process to produce a polymer micropowder in accordance with the present disclosure. Two different polymer micropowders were formed. In a first set of experiments, the multilobal, high density polyethylene particles were subjected to irradiation for crosslinking the polymer prior to grinding. In a second set of experiments, a grinding aid was combined with the multilobal, high density polyethylene polymer particles prior to being fed to the jet mill.

Grinding was conducted in an AFG jet mill commercially available from the Hosokawa Alpine Group.

### Sample No. 1: Crosslinking

In this experiment, the multilobal, high density polyethylene particles had an initial particle size (D50) determined by laser scattering of 60 microns. The particles were crosslinked by being exposed to x-rays in an amount of 200 kGy.

After grinding, the following results were obtained:

| Sample No. 1 | Before Grinding | After Grinding |
|---|---|---|
| Particle size (D50) (microns) | 60 | 9 |
| determined by laser scattering | | |
| VN(mL/g) (ISO Test 1628) | 2100 | 2100 |
| Bulk density after grinding (g/cc) | | 0.25 |
| (ISO Test 60) | | |

### Sample No. 2: Use of a Grinding Aid

In this experiment, the multilobal, high density polyethylene polymer particles were combined with a grinding aid and subjected to the same jet milling process as described above. The grinding aid used was sodium chloride particles having a sub 20 micron particle size and being present in an amount of less than about 50% by weight.

The following results were obtained:

| Sample No. 2 | Before Grinding | After Grinding |
|---|---|---|
| Particle size (D50) (microns) | 110 | 12 |
| determined by laser scattering | | |
| VN(mL/g) (ISO Test 1628) | 400 | 400 |
| Bulk density after grinding (g/cc) | | 0.25 |
| (ISO Test 60) | | |

As shown above, the grinding process of the present disclosure produced extremely small particles having a median particle size of about 9 microns and about 12 microns respectively. The high density polyethylene polymer contained in the polymer micropowder had a melting temperature of less than 135° C. and displayed a Shore D hardness of less than about 61.

As also shown above, due to the particle morphology, the resulting polymer micropowder had an extremely low bulk density, which provides numerous advantages and benefits in terms of handling, processability, and/or mechanical properties.

### Example No. 2

Multilobal polyethylene particles commercially available from Celanese International of Dallas, Texas, were fed through a grinding process to produce a polymer micropowder similar to the process described in Example No. 1. In this example, high density polyethylene particles were subjected to grinding by being fed to a jet mill. Grinding was conducted in a jet mill commercially available from the Hosokawa Alpine Group.

After grinding, the following results were obtained:

| Sample No. 3 | After Grinding |
|---|---|
| Particle size (D50) (microns) | 13 |
| determined by laser scattering | |
| Avg. Molecular Weight (g/mol) | 0.4 × 10⁶ |
| determined using Margolies | |
| equation | |
| Bulk density after grinding (g/cc) | 0.30 |
| (ISO Test 60) | |
| Elongated Stress (MPa) ISO | Less than 0.01 |
| Test 11 542-2 | |
| Density (g/cc) ISO Test 1183, | 0.95 |
| Method A | |
| Mass Melt-Flow Rate (g/10 min) | 3.6 |
| ISO Test 1133 at 190 C. and 21.6 | |
| Kg | |
| Intrinsic Viscosity (IV) (mL/g) | 400 |
| ISO Test 1628, Part 3 | |

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only and is not intended to limit the invention so further described in such appended claims.

What is claimed:

1. A polymer micropowder comprising:
polymer particles having a median particle size (D50) of less than about 15 microns, the polymer particles comprising a high density polyethylene polymer, the high density polyethylene polymer having an average molecular weight of greater than about 300,000 g/mol, the polymer particles displaying a bulk density of less than 0.39 g/cm³ when tested according to ISO Test 60.

2. A polymer micropowder as defined in claim 1, wherein the polymer particles have a median particle size (D50) of less than about 12 microns.

3. A polymer micropowder as defined in claim 1, wherein the polymer particles have a median particle size (D50) of less than about 11 microns.

4. A polymer micropowder as defined in claim 1, wherein the polymer particles have a median particle size (D50) of less than about 10 microns.

5. A polymer micropowder as defined in claim 1, wherein the polymer particles display a bulk density of less than about 0.38 g/cm³.

6. A polymer micropowder as defined in claim 1, wherein the high density polyethylene polymer has an average molecular weight of greater than about 350,000 g/mol.

7. A polymer micropowder as defined in claim 1, wherein the polymer particles comprise ground particles.

8. A polymer micropowder as defined in claim 1, wherein the polymer particles comprise remnants of nodes separated from multi-lobal-shaped polymer particles.

9. A polymer micropowder as defined in claim 1, wherein the high density polyethylene polymer has a melting temperature of less than about 135.5° C.

10. A polymer micropowder as defined in claim 1, wherein the high density polyethylene polymer displays a Shore D hardness of less than about 63.

11. A polymer micropowder as defined in claim 1, wherein at least a portion of the high density polyethylene polymer contained in the polymer particles has been crosslinked.

12. A molded article comprising the polymer micropowder as defined in claim 1.

13. A molded article as defined in claim 12, wherein the molded article comprises a porous membrane.

14. A molded article as defined in claim 13, wherein the porous membrane has a thickness of from about 3 microns to about 25 microns, has a porosity of from about 25% to about 60%, and displays a Gurley permeability of from about 50 mL/min to about 500 mL/min.

15. An energy storage device comprising an anode, a cathode, and a separator positioned between the anode and the cathode, the separator comprising the porous membrane as defined in claim 13.

16. An electrode comprising a film comprising a network of an active material held together by a binder, the binder comprising the polymer micropowder of claim 1.

17. An electrode as defined in claim 16, wherein the active material comprises a carbon material, such as graphite.

18. A process for producing a polymer micropowder comprising:
grinding high density polyethylene particles, the high density polyethylene particles having a multilobal shape comprising a network of nodes and wherein, during grinding, remnants of the nodes are separated from the multilobal-shaped polymer particles, the resulting polymer particles having a median particle size (D50) of less than about 15 microns, the polymer particles displaying a bulk density of less than 0.39 g/cm³ when measured according to ISO Test 60.

19. A process as defined in claim 18, further comprising the step of crosslinking the high density polyethylene polymer contained in the multilobal-shaped polymer particles prior to grinding.

20. A process as defined in claim 19, wherein the high density polyethylene polymer is crosslinked by being exposed to irradiation, such as x-rays or gamma rays.
